(19) United States
(12) Patent Application Publication
(10) Pub. No.: US 2026/0281602 A1
(43) Pub. Date: Sep. 17, 2026

(54) WEARABLE AUDIO DEVICE WITH HEAD STATE DETECTION

(71) Applicant: Bose Corporation, Framingham, MA (US)

(72) Inventors: Brandon Olmos, Brookline, MA (US); Max Pagnucco, Somerville, MA (US)

(73) Assignee: Bose Corporation, Framingham, MA (US)

(21) Appl. No.: 19/081,495

(22) Filed: Mar. 17, 2025

(51) Int. Cl. H04R 1/10; G10K 11/178

(52) U.S. Cl. CPC H04R 1/1041; G10K 11/17854; G10K 11/17881

(57) ABSTRACT

A wearable audio device with head state detection, includes an acoustic driver positioned to provide an acoustic signal to a user when the wearable audio device is worn and a drive signal is provided to the acoustic driver; a system microphone outputting a system microphone signal, wherein the system microphone signal is representative of the acoustic signal; and a control circuit, configured to: generate an anti-noise signal based on a feedback signal wherein the feedback signal comprises the system microphone signal and an injected content signal; generate an estimate of the feedback signal in the off-head state; and determine a state of the wearable audio device by comparing the feedback signal to the estimate of the feedback signal, wherein the state of the wearable audio device represents whether the wearable audio device is on-head or off-head.

### FIELD OF THE DISCLOSURE

The present disclosure is generally directed to a wearable audio device with head state detection.

### BACKGROUND

Modern headphones sometimes include features to detect when the user has removed (i.e., “doffed”) the headphones. Upon detecting the doff, the headphones are typically designed to take a related action, such as pausing playback until the headphones are again donned. Such doff detection designs typically rely on a sensor, such as a capacitive sensor, to determine when the headphones have been doffed or donned. Requiring a dedicated sensor to detect when the headphones are doffed or donned necessarily adds an additional cost to the headphone's bill of materials.

### SUMMARY

The below examples can be combined in any way technically possible.

According to an aspect, wearable audio device with head state detection, includes: an acoustic driver positioned to provide an acoustic signal to a user when the wearable audio device is worn and a drive signal is provided to the acoustic driver; a system microphone outputting a system microphone signal, wherein the system microphone signal is representative of the acoustic signal; and a control circuit, configured to: generate an anti-noise signal based on a feedback signal wherein the feedback signal comprises the system microphone signal and an injected content signal; generate an estimate of the feedback signal in an off-head state; and determine a state of the wearable audio device by comparing the feedback signal to the estimate of the feedback signal, wherein the state of the wearable audio device represents whether the wearable audio device is on-head or off-head.

In an example, comparing the feedback signal to the estimate of the feedback signal comprises generating a metric of similarity between the feedback signal and estimate of the feedback signal and comparing the metric of similarity to a threshold.

In an example, the metric of similarity is generated with an adaptive filter.

In an example, the adaptive filter is a least means squared filter.

In an example, the feedback signal and the estimate of the feedback signal are each filtered before the feedback signal is compared to the estimate of the feedback signal.

In an example, the anti-noise signal is further based on an outer microphone signal, the outer microphone signal being output from an outer microphone and being representative of ambient noise.

In an example, the control circuit is further configured to perform at least one action upon determining that the state of the wearable audio device represents a state change.

In an example, the at least one action comprises pausing audio playback.

In an example, the at least one action comprises adjusting an aware mode.

In an example, the estimate of the feedback signal in the off-head state is based on inputting an outer microphone signal and the injected content signal to filters modeling transfer function of the wearable audio device in an off-head state.

According to an aspect, wearable audio device with head state detection, includes: an acoustic driver positioned to provide an acoustic signal to a user when the wearable audio device is worn and a drive signal is provided to the acoustic driver; a system microphone outputting a system microphone signal, wherein the system microphone signal is representative of the acoustic signal; and a control circuit, configured to: generate an anti-noise signal based on a feedback signal wherein the feedback signal comprises the system microphone signal and an injected content signal; generate an estimate of the feedback signal in an on-head state; and determine a state of the wearable audio device by comparing the feedback signal to the estimate of the feedback signal, wherein the state of the wearable audio device represents whether the wearable audio device is on-head or off-head.

In an example, comparing the feedback signal to the estimate of the feedback signal comprises generating a metric of similarity between the feedback signal and estimate of the feedback signal and comparing the metric of similarity to a threshold.

In an example, the metric of similarity is generated with an adaptive filter.

In an example, the adaptive filter is a least means squared filter.

In an example, the feedback signal and the estimate of the feedback signal are each filtered before the feedback signal is compared to the estimate of the feedback signal.

In an example, the anti-noise signal is further based on an outer microphone signal, the outer microphone signal being output from an outer microphone and being representative of ambient noise.

In an example, the control circuit is further configured to perform at least one action upon determining that the state of the wearable audio device represents a state change.

In an example, the at least one action comprises pausing audio playback.

In an example, the at least one action comprises adjusting an aware mode.

In an example, the estimate of the feedback signal in the on-head state is based on inputting an outer microphone signal and the injected content signal to filters modeling transfer function of the wearable audio device in an on-head state.

According to another aspect, a method for head state detection of a wearable audio device, includes: generate an anti-noise signal based on a feedback signal wherein the feedback signal comprises a system microphone signal and an injected content signal, wherein the system microphone signal is representative of an acoustic signal provided to a user by an acoustic driver; generate an estimate of the feedback signal in an off-head state; and determine a state of the wearable audio device by comparing the feedback signal to the estimate of the feedback signal, wherein the state of the wearable audio device represents whether the wearable audio device is on-head or off-head.

According to another aspect, a method for head state detection of a wearable audio device, includes: generate an anti-noise signal based on a feedback signal wherein the feedback signal comprises a system microphone signal and an injected content signal, wherein the system microphone signal is representative of an acoustic signal provided to a user by an acoustic driver; generate an estimate of the feedback signal in an on-head state; and determine a state of the wearable audio device by comparing the feedback signal to the estimate of the feedback signal, wherein the state of the wearable audio device represents whether the wearable audio device is on-head or off-head.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a block diagram of a wearable audio device with head state detection, according to an example.

FIG. 2 is a block diagram of a head state detection circuit, according to an example.

FIG. 3A depicts a plot free-air measurement of the derived transfer function Gₖₐ in both magnitude and phase and the transfer function model Gₖₐ in both magnitude and phase, according to an example.

FIG. 3B depicts a plot free-air measurement of the derived transfer function Gₖₒ in both magnitude and phase and the transfer function model Gₖₒ in both magnitude and phase, according to an example.

FIG. 4 depicts a plot of the detection of doff events using an example of system of FIGS. 1 and 2.

FIG. 5 is a block diagram of a wearable audio device with head state detection, according to an example.

FIG. 6A is a partial method for detecting a doff or don event of a wearable audio device, according to an example.

FIG. 6B is a partial method for detecting a doff or don event of a wearable audio device, according to an example.

### DETAILED DESCRIPTION

Turning now to the figures, there is generally disclosed a wearable audio device with head state detection. Previous methods of detecting a doff without a dedicated sensor are, for example, described in U.S. Pat. No. 10,091,597 herein incorporated by reference in its entirety. This previous design, however, relied upon modeling of a drive signal provided to the acoustic driver in the off-state in a feedforward active noise reduction (ANR) topology. Such a design relied upon a fixed feedforward ANR filter, which could not be adjusted (e.g., adaptively or based on a personalized user input) without negatively impacting the equalization of the audio provided to the user. Accordingly, head-state detection that can be used without an additional sensor and can allow a configurable or dynamic ANR filter without negatively impacting equalization of the audio, is described in this disclosure.

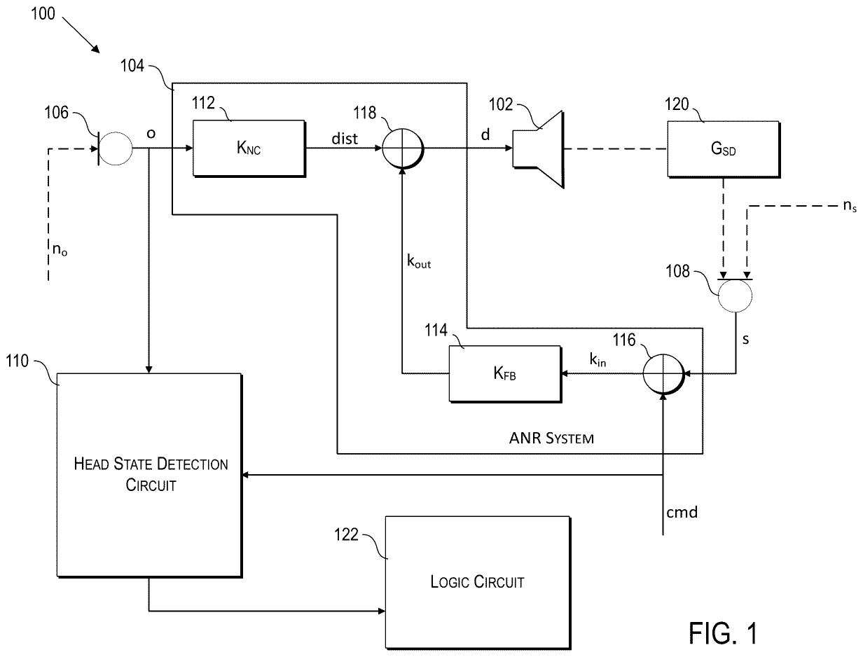

FIG. 1 depicts a block diagram of a pair of wearable audio device 100 with ANR and doff detection, according to an example. As shown, wearable audio device 100 includes an acoustic driver 102 that is positioned to provide an acoustic signal to the user (for example, acoustic driver 102 can be positioned within an earcup or an earbud nozzle of wearable audio device 100). Acoustic driver 102 receives drive signal d and, in response, transduces an acoustic signal to the user. Drive signal d can include audio content (e.g., music, speech, aware mode) as well as an anti-noise signal generated by ANR system 104 configured to reduce ambient noise perceived by the user. In this example, ANR system 104 generates the anti-noise signal according to microphone inputs from outer microphone 106 producing outer microphone signal o and system microphone 108 producing system microphone signal s.

Outer microphone 106 is positioned to provide an outer microphone signal representative of ambient noise. Thus, in an example, outer microphone 106 can be in acoustic communication with the exterior of wearable audio device 100 to detect ambient noise, as such noise is received at outer microphone 106. It will be understood that ambient noise is not constant across space, i.e., ambient noise varies in terms of physical location. Outer microphone 106 can be positioned to detect ambient noise as such noise is generally present at the user's ear, i.e., in a location useful for providing a signal that can be adapted for ANR (and, in certain examples, aware mode) of wearable audio device 100. And thus, the outer microphone signal being representative of ambient noise refers to such noise as is generally present at the user's ear, with sufficient fidelity for use with ANR (and, in certain examples, an aware mode).

System microphone 108 is positioned to detect the acoustic signal provided to the user, which can comprise the acoustic signal output from acoustic driver 102, well as residual noise nₛ, left uncancelled by the anti-noise signal provided as part of drive signal d. System microphone signal s thus receives the acoustic signal output from acoustic driver 102 according to transfer function G_{SD}, representing the path from acoustic driver 102 to system microphone 108. It will be understood that the physical path from acoustic driver 102 to microphone 108 (represented by transfer function G_{SD}) is slightly different from the acoustic path to the user's ear drum. Likewise, the noise signal nₛ, as detected by system microphone 108, will vary slightly from the noise present at the user's ear drum. A person of ordinary skill in the art will understand that detecting the acoustic signal provided to the user refers to a detection that sufficiently approximates the signal heard by the user to be useful for providing a feedback signal to ANR system 104. Thus, the system microphone signal being representative of the acoustic signal provided to the user refers to a sufficient representation of such a signal to be useful for ANR.

Generally, it will be understood that system microphone 108 can be positioned within the acoustic volume that includes acoustic driver 102 and at least a portion of the user's ear canal. Such positions can include, for example, the interior of the ear cup of a pair of over-the-ear headphones or an interior surface of an earbud, such as the earbud nozzle.

It should be understood that, although a single outer microphone 106 and a single system microphone 108 are shown, outer microphone 106 can comprise multiple outer microphones providing multiple outer microphone signals o and system microphone 108 can comprise multiple system microphone providing multiple system microphone signals s. To the extent that the ANR system 104 or head state detection circuit 110 uses microphone signal o or microphone signal s, it will be understood by a person of ordinary skill in the art that the methods implemented by these systems can be expanded to account for multiple outer microphone signals o and multiple system microphone signals s.

Further, it should be understood that the outer microphone signal o can itself be the combined result of multiple outer microphones 106. Further, additional processing, such as beamforming, can be used to enhance the ambient noise detected in a certain direction, while reducing the noise in other directions. Accordingly, outer microphone signal o can be the combined result of multiple outer microphone signals and can be the result one or more additional processes, such as beamforming.

In the example of FIG. 1, ANR system 104 sums together two anti-noise signals—a feedforward anti-noise signal and a feedback anti-noise signal—to produce the anti-noise component of drive signal d. The first anti-noise signal is provided by filtering outer microphone signal o with feedforward K_{NC} filter 112 to produce disturbance injection signal dist, which is a feedforward anti-noise signal that reduces the ambient noise perceived by the user when transduced into the acoustic volume by acoustic driver 102. K_{NC} filter 112 is, in this example, a fixed feedforward ANC filter. Such filters are understood in the art and any suitable example of such filters can be used. In alternative examples, an adaptive or configurable fixed filter can be used.

The second anti-noise signal is provided by filtering the summed combination of system microphone signal s and command injection signal cmd at K_{FB} filter 114 to produce feedback output signal Kₒᵤₜ. System microphone signal s and command injection signal cmd are summed together at combiner 116 to produce feedback signal kᵢₙ, the input to K_{FB} filter 114. Command injection signal cmd includes audio content (e.g., music, speech, aware mode) that is desired by the user to be heard within the acoustic volume. (It should be understood that “aware mode” audio content can likewise be generated from outside microphone signal o.)

In this example, K_{FB} filter 114 is a fixed feedback ANC filter, and thus the output signal Kₒᵤₜ includes the content signal from command injection signal cmd and an anti-noise signal that likewise reduces the ambient noise perceived by the user when transduced into the acoustic volume by acoustic driver 102. Such filters are understood in the art and any suitable example of such filters can be used. In alternative examples, K_{NC} filter 112 can be adjusted either adaptively (as are known) or according to a user input designating a user preference of ANR setting.

The disturbance injection signal dist (i.e., the feedforward anti-noise signal) and the feedback output signal kₒᵤₜ are summed at the combiner 118, the result being drive signal d provided to acoustic driver 102 (e.g., via any necessary amplification), which includes both the anti-noise signal resulting from both K_{NC} filter 112 and K_{FB} filter 114 and the audio content from command injection signal cmd.

Head state detection circuit 110, in the example of FIG. 1, receives outer microphones signal o and command signal cmd and compares an estimated feedback signal \hat{k}_{inoff}—generated from inputting outer microphones signal o and cmd signal to a model of certain transfer functions of wearable audio device 100 in the off-state—to feedback signal kᵢₙ. If feedback signal kᵢₙ demonstrates sufficient agreement with estimated feedback signal \hat{k}_{inoff}, it can be determined that the wearable device 100 is in the off-state Stated differently, the physical acoustic properties of wearable audio device 100 will change depending on whether the headphones are worn or removed. While these acoustic properties cannot be measured directly, real-time signals within wearable audio device 100 can be input to predetermined transfer functions of wearable audio device 100 that model these acoustic properties as they exist in the off-head state. The result of inputting real-time signals to the modeled transfer functions is an estimate of the real-time signal with the wearable audio device 100 in the off-head state. This thus provides a signal against which the actual real-time signal can be compared, and sufficient agreement between the estimated real-time signal and the real-time signal indicates that the wearable audio device 100 is in the off-head state.

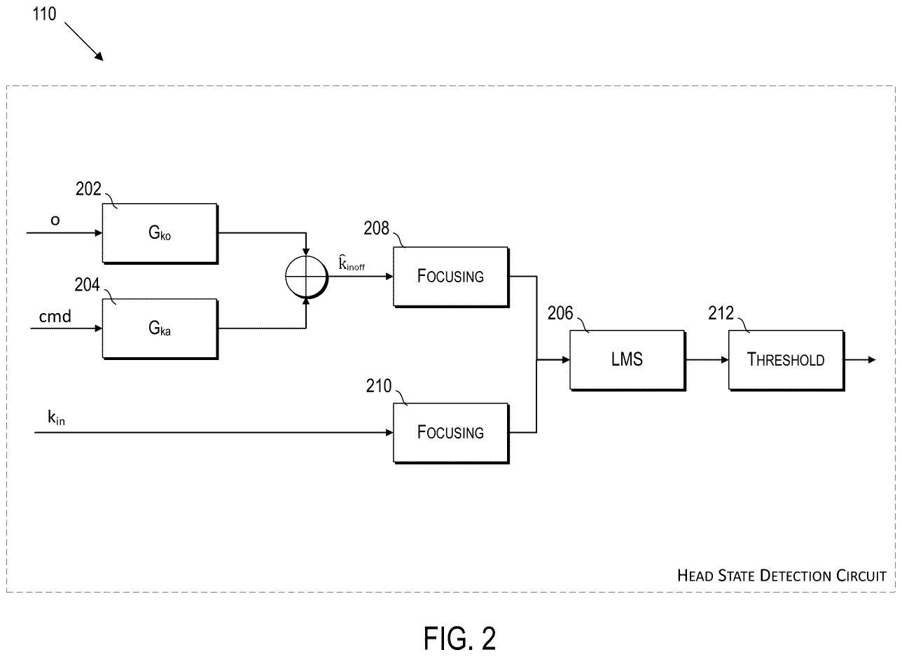

The operation of head state detection circuit 110 is described in more detail in connection with FIG. 2, according to an example. As shown, head state detection circuit 110 includes filters Gₖₒ and Gₖₐ, which receive outer microphone signal o and command injection signal cmd. The output of filters Gₖₒ and Gₖₐ are summed to generate the estimated feedback signal \hat{k}_{inoff}.

Mathematically, the estimated feedback signal in the off-head state can be represented as follows:

$${\hat{k}}_{inoff} = {S}_{off} [ ( {N}_{so} + {G}_{sd} {K}_{nc} ) {n}_{o} + {c}_{md} ]$$

where S_{off} is the sensitivity of the feedback ANR system 104, Nₛₒ is a transfer function from the outer microphone 106 to system microphone 108, G_{sd} is the transfer function from the driver to system microphone 108, K_{nc} is the transfer function of K_{nc} filter 112, nₒ is the noise present in the outside microphone signal o, and c_{md} is the command injection signal cmd.

As will be understood to a person of ordinary skill in the art, the sensitivity of a system can be rendered as:

$$\frac{1}{1 - LG}$$

where LG is the loop gain. Here, the loop gain is G_{sd}K_{fb}, and where K_{fb} is the transfer function of feedback K_{fb} filter 114. Because the feedback signal kᵢₙ is being measured in the off-head state, transfer function G_{SD}, within equation (1) (including within sensitivity S_{off}), represents the transfer function from acoustic driver 102 to system microphone 108 with wearable audio device 100 in the off-head state. Additionally, because Nₛₒ represents the transformation that sounds received at outer microphone 106 undergoes on its path to system microphone 108 (i.e., the transfer function from outer microphone 106 to system microphone 108), the noise input at the system microphone 108 can be omitted in favor of noise input to outer microphone 106 (i.e., noise input to the system microphone 108 is modeled using the noise at outer microphone 106). As a result, Eq. (1) expresses the estimated feedback signal in terms of two input signals: noise in the outer microphone signal nₒ and command injection signal c_{md}. Gₖₒ filter 202 can be represented by the expression S_{off}(Nₛₒ+G_{sd}K_{nc}) and Gₖₐ filter 204 by S_{off}.

In practice, Gₖₒ filter 202 can be generated by measuring the input to system microphone 108 with wearable audio device 100 placed in a noise field. Gₖₐ filter 204 can be generated by playing audio content from acoustic driver 102 via a signal input through cmd injection signal and measuring the output of system microphone 108 with wearable audio device 100 in the off-head state. The measured signals from these two inputs can be used to form transfer functions to create Gₖₒ filter 202 Gₖₐ filter 204. In alternative examples, other points in the loop can be modeled, instead of the feedback signal kᵢₙ. In such examples, the model producing the estimated signal can similarly be compared to the real-time signal to determine sufficient agreement that would indicate the state of the wearable audio device 100

Continuing with FIG. 2, the feedback signal kᵢₙ and the estimated feedback signal \hat{k}_{inoff} are input to least means squared filter (LMS) filter 206 via focusing filters 208, 210. LMS filter 206 will compare feedback signal kᵢₙ and estimated feedback signal \hat{k}_{inoff} and output a value depending on the agreement between the signals. Specifically, as the signals increase in similarity, the output of LMS filter 206 will approach a value of 1. Conversely, the output of LMS filter 206 will approach a value of zero as the signals exhibit increasing dissimilarity. The output of LMS filter 206 thus represents a metric of similarity of the feedback signal kᵢₙ and the estimated feedback signal \hat{k}_{inoff}. This output can be thus compared to a threshold, shown as threshold block 212, to determine whether output of LMS demonstrates sufficient similarity between the signals to warrant a determination that the wearable audio device 100 is off the user's head.

While an LMS filter is disclosed in FIG. 2, it should be understood that other methods of comparing kᵢₙ to \hat{k}_{inoff} can be used. For example, different types of filters such as a recursive least squares (RLS) filter, or a Kalman filter, could be used to generate a metric of similarity.

In other examples, rather than adaptive filters or an algorithm, more direct mathematical measures of similarities can be employed. Most simply, the feedback signal kᵢₙ can be subtracted from estimated feedback signal \hat{k}_{inoff} (or vice versa) and the result compared to a threshold. Such subtraction can occur in the time-domain or in the frequency domain at one or more representative frequencies. Comparing the feedback signal kᵢₙ and estimated feedback signal \hat{k}_{inoff} in the frequency domain can involve, for example performing a DFT of both signals to receive the magnitude of the signals at one or more desired frequencies. These magnitudes can then be compared to determine if the magnitudes are within a predetermined range of each other. It should also be understood that subtraction and comparing to a threshold (in the time-domain or frequency-domain) is a method of determining whether the two signals are within a predetermined range of each other. Any method of determining whether two signals are within a predetermined range (e.g., difference, ratio of magnitudes, etc.) can be used.

Alternatively, mathematical techniques for determining similarity between signals, such as a cross-correlation, can be used. The results of direct measures of similarity can likewise be compared to a threshold to detect the off-head state. Direct mathematical measures, however, are expected to result in quantization noise and so are not preferred to the adaptive techniques.

It will be understood that the exact threshold used by threshold block 212 is a design choice, and can be appropriately set by a person of ordinary skill in the art. Higher thresholds will decrease false positives at the expense of occasionally failing to identify a doff event. Lower thresholds will result in a high rate of detecting true doff events at the expense of occasional false positives.

The output of threshold block 212 can be input to logic circuit 122 to detect a state change of wearable audio device 100. Detection of a state change can be accomplished by comparing successive samples of the head state detection circuit 110 output. A change in the signal output from head state detection circuit 110 between successive samples likely represents a state change. For example, if the output of head state detection circuit 110 changes from low (i.e., the comparison output is less than the threshold) to high (above the threshold), this likely represents the start of a doff state (i.e., a change from on-head to off-head). Conversely if the output of head state detection circuit 110 changes from high to low, this likely represents a change to a don state (i.e., a change from off-head to on-head). In an example, a certain number of samples following the change can be monitored to determine whether the state change is persistent, representing an actual change in state rather than a single transient signal that could result from noise in the system.

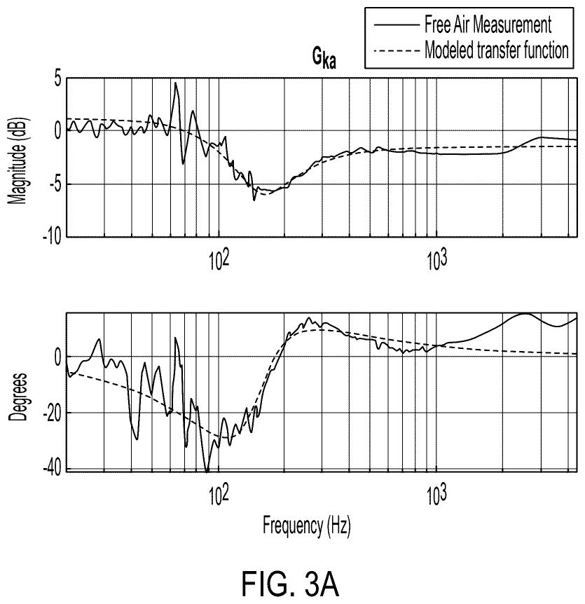

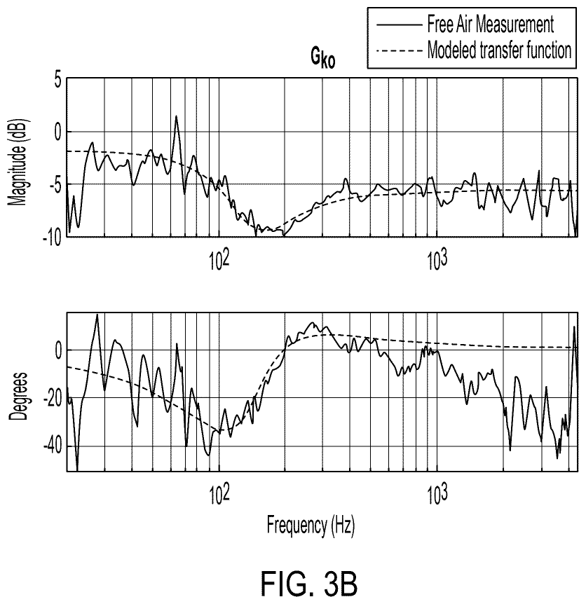

Focusing filters 208, 210 can be used to filter the frequencies input to LMS filter 206 in order to increase tunability, accuracy, and robustness. Turning briefly to FIG. 3A, there is shown the free-air measurement of the derived transfer function Gₖₐ in both magnitude and phase, against the transfer function model of Gₖₐ implemented by filter 204 in the example of FIG. 2. Likewise, where is shown in FIG. 3B the free-air measurement of the derived transfer function Gₖₒ in both magnitude and phase against the transfer function model of Gₖₒ implemented by filter 202 in the example of FIG. 2. As shown, the free-air measurement of both filters exhibits the least amount of variation, and the closest fit to the model, in a range at the center of the plots, with the ends of the plots tending to show divergence between the free-air measurement and the model. Consequently, this is the range in which filters 202, 204 most accurately model the transfer function of the off-head state of the wearable audio device and thus permit the most reliable detection of off-head using LMS filter 206. With this in mind, the frequencies input to LMS filter 206 can be “focused” on a subset of frequencies for which filters 202, 204 exhibit the greatest accuracy. Accordingly, focus filters 208, 210 can be, in an example, a bandpass filter with corner frequencies set to focus the output of filters 202, 204 on the frequency that render the most reliable detections. The actual frequency range of the bandpass filter depends upon the nature of the free-air transfer functions and will thus vary depending on the wearable audio device modeled. A person of ordinary skill in the art will understand, in conjunction with a review of this disclosure, how to select a frequency range that will render the most reliable detections.

Following a state change detection, logic circuit 122 (or separate processing) can initiate a resulting predetermined action. For example, the action can include notifying a separate device of the state change, notifying a separate earpiece of wearable audio device 100 of the state change, pausing/resuming playback, adjusting the aware-mode settings, adjusting the ANR settings, powering down or on, entering standby, or some combination of these events. As an example, if the state change of wearable audio device 100 is a doff event (i.e., a change from on-head to off-head) logic circuit 122 can pause playback of audio to wearable audio device 100. Logic circuit 122 can cause playback to resume if the state change of wearable audio device 100 subsequently is a don event (i.e., a change from off-head to on-head).

If the wearable audio device 100 is earbuds (or wearable similarly including separate ear pieces), removal of one earbud can cause the removed earbud to notify the other earbud of the state change. Each earbud can take the same or different actions. For example, the removed earbud can cause playback to pause, while the earbud remaining on-head can continue playback or can take a different action, such as entering an aware mode or decreasing ANR to permit a user to better hear the surroundings (as removing a single earbud often indicates a user is trying to hear something in the environment). Similarly, removing one earbud can cause wearable audio device 100 to exit a virtualized audio state, as virtualized audio relies on differences between audio delivered to the ears to be effective.

Furthermore, or alternatively, the state change can precipitate notifying a mobile device of the event. The mobile device can then take a predetermined action, such a pausing or resuming playback of audio content, adjusting ANR or aware settings, changing virtualized audio setting, terminating a phone call, causing audio content to play from a separate device (e.g., mobile phone speaker), or other suitable actions following the doff or don of a wearable audio device.

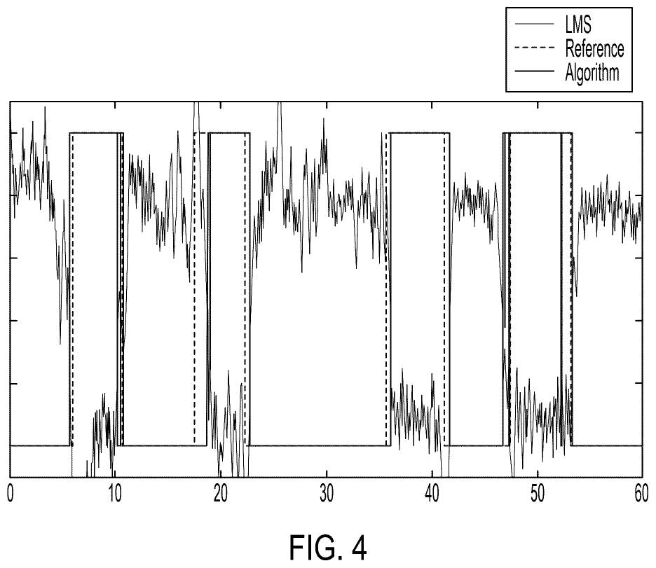

FIG. 4 demonstrates the detection of doff events using an example of system of FIGS. 1 and 2. In this example, the detection threshold of threshold block 212 was set to 0.3. A user wearing the headphones indicated via a footswitch when the headphones were removed and put back on. FIG. 4 demonstrates high agreement between the user removing the headphones and detection of the removal via monitoring the output of LMS filter 206.

In another example, the outputs of filters 202, 204 can each be filtered into multiple frequency bands and the frequency bands can be input to independent LMS filters to render multiple signals that can be thresholded. In this example, the real-time feedback signal can likewise be divided into multiple bands, each frequency band of the output of filter 202, 204 being compared to corresponding frequency band of feedback signal Kin using the LMS filter (or other comparison technique as described above). The results of the banded thresholds can be used to detect state changes. For example, the ultimate detected state can depend on the number of thresholded outputs identifying a change in state. The number of thresholds required to make the ultimate decision of the state change be varied can be set according to desired sensitivity.

While the above description generally applies to off-head detection, in alternative examples, an on-head state can be detected instead. This can be accomplished, for example, by replacing the Gₖₒ and Gₖₐ filters with equivalent filters designed to model the equivalent transfer functions in the on-head state. For example, Gₖₐ can instead be created by playing audio content and measuring the signal at system microphone 108 while a user is wearing the wearable audio device. Likewise, Gₖₒ can be created by measuring the system microphone 108 output in a noise field while the user is wearing the wearable audio device. The result of the sum of the outputs of Gₖₒ and Gₖₐ would be the estimate of feedback signal kᵢₙ in the on-head state, i.e., \hat{k}ᵢₙₒₙ. This estimated signal can then be compared to kᵢₙ (in the same fashion as \hat{k}_{inoff} is compared to kᵢₙ, as described above) to detect if wearable audio device 100 is on the user's head. From this detection, as described above, any state changes from on-head to off-head or off-head to on-head can be identified, and a predetermined action can be taken according to the type of state change detected. Generally, the predetermined actions will be the same for the same types of state changes (on-head to off-head detected or off-head to on-head detected).

In an alternative example, both the on-head and off-head detection can be used to determine a state change. In other words, both \hat{k}ᵢₙₒₙ and \hat{k}_{inoff} can be used to determine a state change from on-head to off-head or vice versa. For example, separate sets of filters can be used to determine both estimated \hat{k}ᵢₙₒₙ and \hat{k}_{inoff} and the results of each compared and thresholded to determine whether an on-head or off-head state exists. In one example, to decrease the rate of false positive detections, a state change can be detected only when the thresholds of resulting from both \hat{k}ᵢₙₒₙ and \hat{k}_{inoff} identify a state change (i.e., within a predetermined window of time). In an alternative example, to increase sensitivity, a state change can be detected when either of the thresholds of resulting from both \hat{k}ᵢₙₒₙ and \hat{k}_{inoff} identify a state change.

In addition to on-head, other measurable states can be detected, where an updated model of Gₖₒ and Gₖₐ for that specific state are derived. For example, the off-head state can be subdivided into multiple possible off-head states to identify particular off-head states to provide greater granularity. Such states can include a grasped state, where the headphones are grasped by the user (this can, alternatively, be called the in-hand state), and an on-surface state, where the wearable audio device is resting on a surface such as a table or desk. Such a detected state can be used, for example, to determine whether the device should enter a standby mode or power down. For example, if the state is detected as grasped within the user's hand, one action can be taken such as pausing playback, whereas if the state is detected as on surface (particularly for a certain period of time) the device can enter standby or power down.

It should be understood that either a grasped state or an on-surface state of wearable audio device 100 can be used to generate the off-head state detection filters 202 and 204, as described above. The grasped state and on-surface state are provided as examples of additional detected states that could be leveraged to provide further potential actions in the off-head state.

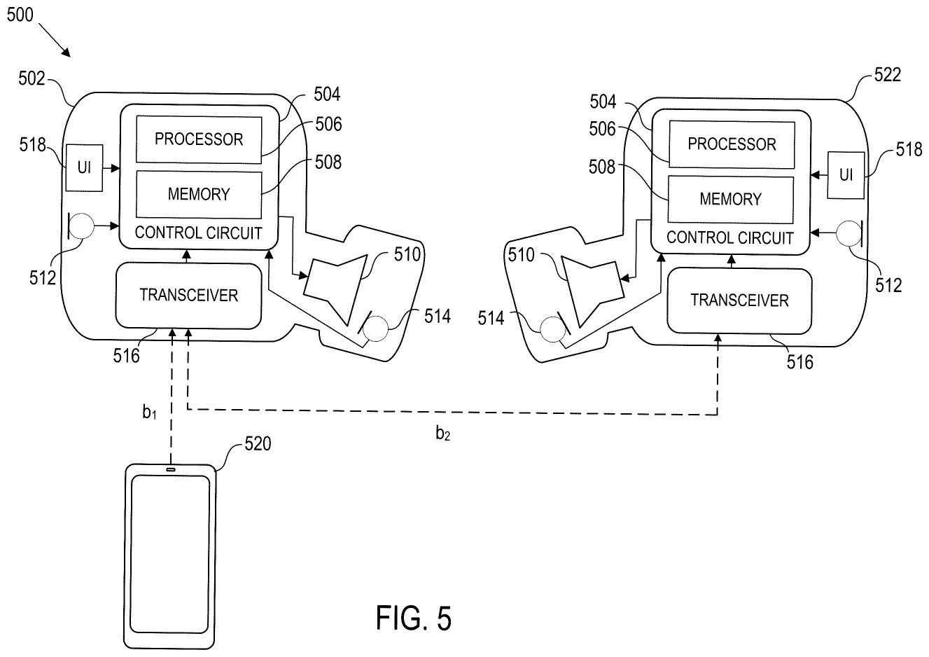

FIG. 5 depicts simplified block diagram of an example wearable audio device 500. In this example, the wearable audio device is a pair of earbuds, though, for the purposes of this disclosure, the term “wearable audio device” is used as an umbrella term for any personal audio wearable worn on a user's head. As such, the term can encompass form factors such as over-ear headphones, on-ear headphones, ear buds, in-ear monitors, closed or open headphones, hearing aids, aviation headsets etc. As shown in FIG. 5, left earbud 502 includes control circuit 504, which can include processor 505 and memory 508. Memory 508 can be a non-transitory storage medium storing program code to be executed by processor 505 for implementing the various processes and methods described in this disclosure, including detecting a head state, as well as any additional functions such as ANR. In an example, control circuit 504 can implement the topology described in conjunction with FIG. 1. Thus, as shown, wearable audio device further includes acoustic driver 510, outside microphone 512 (positioned to detect ambient noise), and system microphone 514 (positioned to detect the acoustic signal delivered to the user). Left earbud 502 further includes a user interface U1 518 (e.g., one or more buttons, a touch interface, etc.) for a user to input various instructions. These instructions can include on/off, adjusting ANR settings, aware mode, etc.

In this example, a transceiver is also included (e.g., a Bluetooth module) for communicating with mobile device 520 (via wireless connection b1) and for communicating with right earbud 522 (via wireless connection b2). (Alternatively, a wired connection can be used.) In this example, a second user interface can be provided on mobile device 520, for adjusting ANR settings, aware mode, etc. In addition, the mobile device 520 can provide a content signal to be transduced by acoustic driver 510, such as music, telephone calls, podcasts, etc. As described above, a detected state change can precipitate the mobile device taking a predetermined action. For example, the mobile device 520 can be notified of a doff/don event of wearable audio device 500 then take a predetermined action, including: pausing or resuming playback of audio content, adjusting ANR or aware settings, changing virtualized audio setting, terminating a phone call, causing audio content to play from a separate device (e.g., mobile device 520 speaker), or other suitable actions following the doff or don of a wearable audio device.

In this example, the communications between wearable audio device 500 and mobile device 520 are sent to left earbud 502, which forwards the instructions to right earbud 522. In alternative example, mobile device 520 can deliver instructions to both left earbud 502 and right earbud 522 individually, or to right earbud 522 which forwards the communication to left earbud 502.

In this example, right earbud 522 includes the same components as left earbud 502, and can thus independently detect doff/don events of right earbud 522. In other words, right earbud 522 can detect if it has been doffed or donned, irrespective of the state of left earbud 502. It should be understood that a single control circuit 504 can be used in certain form factors (such as over-the-ear headphones). Such a single control circuit could detect the state of the entire audio device. For example, if the audio wearable device is a pair of over-the-ear headphones that includes a headband connecting two earcups, it may be desirable to detect the doff/don state of the entire pair of headphones, rather than each single ear, since typically both earcups are either off-head or on-head at the same time. In such cases, ANR signals can be calculated for both left and right earcups, and thus feedback signal for either earcup could be used to detect the state of the wearable audio device. Alternatively, the state of both earcups could be detected. In such an example, the control circuit 504 could use either or both feedback signals to determine the state of the wearable audio device.

Any suitable circuitry can be used to implement control circuit 504 as described in FIG. 5, as well as the processing described in conjunction with FIGS. 1 and 2 (including the filters and operations of ANR system 104, head state detection circuit 110, and logic circuit 122), and the methods described below. Such circuitry can include one or more processors, such as digital signal processors (DSPs), microcontrollers, microprocessors, systems-on-chip (SoCs), field-programmable gate arrays (FPGAs), etc, together with one or more non-transitory storage media (such as non-volatile storage) that can store program code to be executed on the one or more processors. (Certain examples, such as microcontrollers and SoCs, include both processor(s) and at least one non-transitory storage medium in a single self-contained package.) Alternatively, or additionally, non-processor-based hardware, such application-specific integrated circuits (ASICs) can be used. Together, the circuitry for implementing the processing and methods described in this disclosure can be referred to as a control circuit. The control circuit can thus be a single discrete component (such as a DSP), or can be a combination of components (e.g., one or more microcontrollers or ASICs) working in concert to accomplish the processing and methods described in this disclosure. In general, the types of individual components described herein, including digital filters (ANC filters, transfer function filters, focusing filters, LMS filters, RLS filters etc.) and combiners are understood in the art, and any suitable circuit(s) for implementing these components can be used.

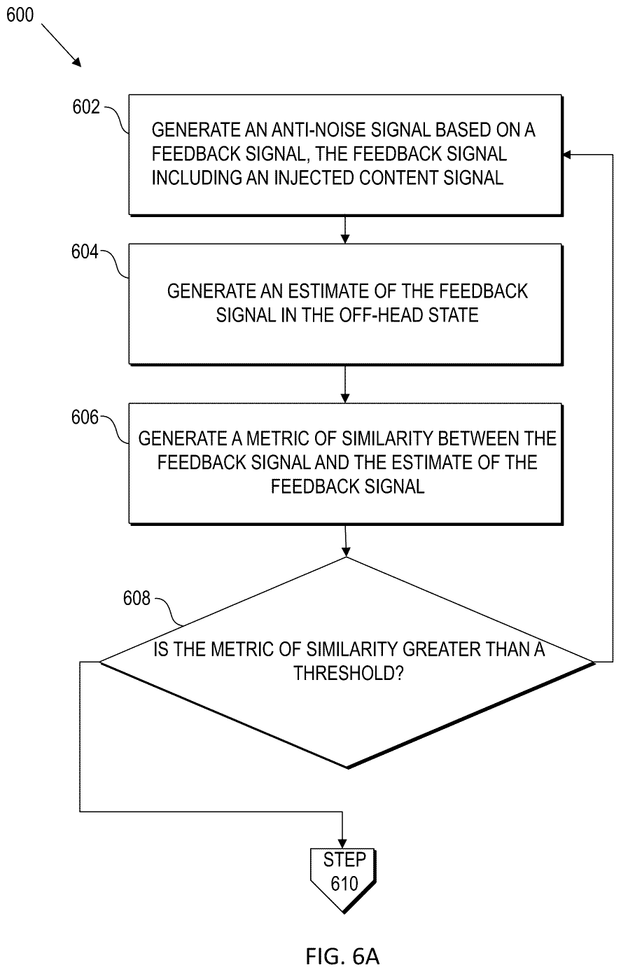

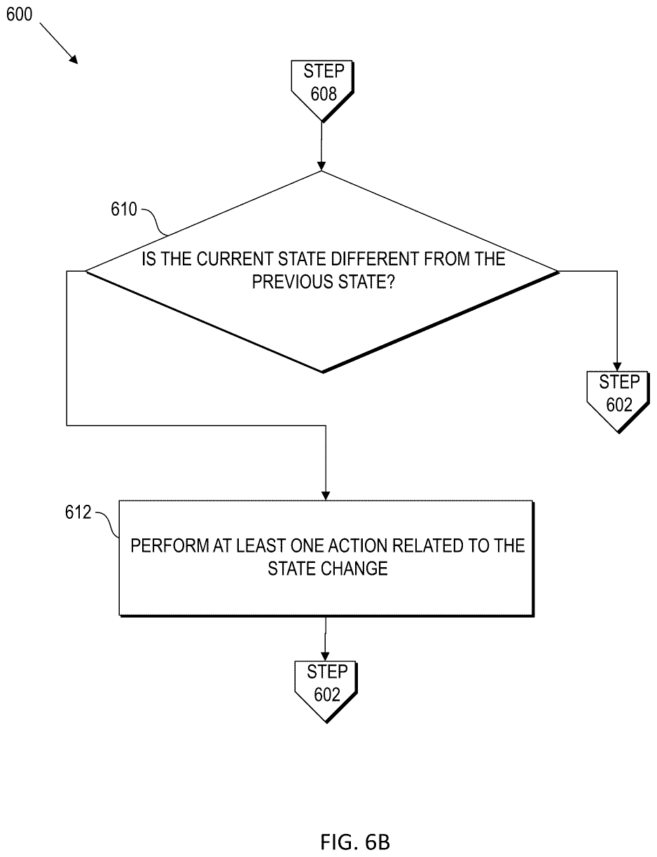

Turning now to FIG. 6 there is shown a method for detecting a doff (or, alternatively, a don) action of headphones. The steps of method 600 can be accomplished by a control circuit, as described above, which can include one or more processors, ASICS, and/or associated hardware to accomplish the steps. Accordingly, the steps of method 600 can, in an example, be stored in a non-transitory storage medium (such as non-volatile storage) and executed with one or more processors. The steps of the method 600 require at least one acoustic driver that is positioned to deliver an acoustic signal to a user. As such, the acoustic driver can be located within, e.g., an ear cup or a nozzle of an earbud.

At step 602, an anti-noise signal is generated based on a feedback signal, the feedback signal including an injected content signal. The injected content signal (also called a command signal) can include audio content such as music, speech, or aware mode inputs. The feedback signal comprises a system microphone signal that is received from at least one system microphone positioned to detect the acoustic signal delivered to a user. The system microphone signal is thus representative of the acoustic signal delivered to the user. (It will be understood that this signal being representative of the acoustic signal delivered to the user refers to sufficient representation for being useful for ANR.) The anti-noise signal can thus be generated from a feedback anti-noise filter receiving the feedback signal.

The anti-noise signal can be further based on a feedforward signal. The feedforward signal can be an anti-noise signal output from a feedforward anti-noise filter that generates the feedforward signal (an anti-noise signal) based on a signal from at least one outside microphone. The outside microphone signal can thus be representative of ambient noise. (The outside microphone being representative of ambient noise refers to sufficient representation of such noise to be useful for ANR, and, in some cases, an aware mode signal.) Accordingly, the anti-noise signal can be the result of the combination of the anti-noise signal from the feedback anti-noise filter and the feedforward anti-noise filter.

At step 604, an estimate of the feedback signal in the off-head state is generated. The estimate can be based on filters that model the physical acoustic properties (i.e., transfer functions) of the wearable audio device. More particularly, one or more real-time signals of the wearable audio device can be input to such filters to generate the estimates. Thus, in an example, and as described above, the output can be based on the injected content signal and outside microphone signal. Specifically, the injected content signal could be input to one filter, while the outside microphone signal could be input to another filter, each filter modeling different transfers. The transfer functions of the filters are based on the physical properties of the wearable audio device in the off-head state. The mathematical definitions of these transfer functions could be given by Eqs. (1)-(3), as described above. The sum of these transfer function outputs is an estimate of the feedback signal in the off-head state.

While the above description generally applies to off-head detection, in alternative examples, an on-head state can be detected instead. This can be accomplished, for example, by using filters designed to model the equivalent transfer functions in the on-head state.

In addition to on-head and off-head states, other measurable states can be detected, where the filters that model transfer functions for that specific state are used. Such states can include, for example, a grasped state, where the headphones are grasped by the user. Alternatively, another detected state can include an on-surface state, where the wearable audio device is resting on a surface such as a table or desk.

At step 606, a metric of similarity between the feedback signal and the estimate of the feedback signal is generated. In an example, the metric of similarity can be the output of an adaptive filter, such as an LMS, RLS, or Kalman filter. Though more direct measures of similarity, such as comparison (e.g., subtraction) of signals in the time-domain or representative frequencies in the frequency domain or a cross-correlation could be used. The metric of similarity is a real number that represents the similarity (or dissimilarity) of the two signals. A person of ordinary skill will recognize that there are any number of ways to compare two signals, and any suitable such method can be used.

In another example, the outputs of the filters that model the physical acoustic properties can each be filtered into multiple frequency bands and the frequency bands, together with the corresponding frequency bands of the feedback signal can be input to independent LMS filters to render multiple signals that can be thresholded. (As described above, other metrics of similarities can be used.)

It should be understood that the measure of similarity can be based on “focused” features of the feedback signal and the estimated feedback signal. In an example, the feedback signal can be filtered with a bandpass filter to result in focusing on the frequencies of the signals to those frequencies for which the transfer functions of the wearable audio device demonstrate the least variations. Stated differently, the bandpass filters can be configured to filter out signals for which the modeled transfer function(s) that produces the estimated feedback signal does not closely match the actual transfer function. A person of ordinary skill in the art will recognize that this frequency range will vary depending on the acoustic properties of the wearable audio device modeled.

At step 608, the metric of similarity is compared to a threshold to determine if it is greater than the threshold, that is, compared to the threshold to determine if two signals are sufficiently similar to warrant a detection of an off-head state (or, alternatively, an on-head state, if transfer functions used to model an on-head state are used instead). Precisely what the threshold is is a design choice, balancing sensitivity to state changes with risk of false positives, and will likewise depend on the acoustic properties of the wearable audio device.

At step 610, it is determined whether the detected state of step 608 represents a state change of the wearable audio device (i.e., from on-head to off-head or from off-head to on-head). This can be accomplished by determining whether the current state differs from the state from the most recent detected state (e.g., the state from the previous sample, if the state is calculated for each incoming sample). It should be understood that in other examples, to increase certainty and reduce false detections, method 600 can require multiple consecutive detections or a certain number of detections with a predetermined window of time before a state change is identified.

In an alternative example, both an on-head and off-head detection can be used to determine a state change. For example, separate sets of filters can be used to determine estimated feedback signals in both on-head and off-head states, the results of each compared and thresholded to determine whether an on-head or off-head state exists. In one example, to decrease the rate of false positive detections, a state change can be detected only when the thresholds of resulting from both identify a state change (i.e., within a predetermined window of time). In an alternative example, to increase sensitivity, a state change can be detected when either of the thresholds resulting from the on-head and off-head estimated feedback signals identify a state change.

Further, if the output of the filters implementing the transfer functions are banded, as described above, the banded estimated feedback signal can be used to determine whether a state change has occurred. For example, the ultimate determined state can depend on the number of thresholded outputs identifying a change in state. The number of thresholds required to make the ultimate decision of the state change be varied can be set according to desired sensitivity.

At step 612, at least one action related to the state change is performed. This action can include, for example, notifying a separate device of the state change, notifying a separate of earpiece of the state change, adjusting the aware-mode settings, adjusting the ANR settings, powering down or on, entering standby or resuming full operation, or some combination of these events. The precise action taken will also depend on whether the state change detected is a doff event or a don event. If wearable audio device includes two separate earpieces (e.g., if the form factors are earbuds), each earpiece can take different actions if only earpiece one detects the state change. Thus, if only one earpiece is removed, the removed earpiece can pause playback or enter standby, while the remaining earpiece can be enter an aware mode. Furthermore, a separate device, such as a connected mobile device can be alerted of the state change (via a signal sent, e.g., over Bluetooth). The separate device can then take an action, such as pause playback, enter aware mode, terminate a phone call, etc.

If additional states besides on-head/off-head are detected (e.g., in-hand or on-surface states), the resulting action can depend on the state detected. For example, if the state is detected as within the user's hand, one action can be taken such as pausing playback, whereas if the state is detected as on surface (particularly for a certain period of time) the device can enter standby or power down.

The above-described detection system and method has, among other things, the advantage of being unconnected to the actual control system, i.e., it does not insert any signals into the control system. The result is that doff/don can be detected without negatively impacting the equalization of the audio delivered to the user.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. As noted above, when any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

What is claimed is:

1. A wearable audio device with head state detection, comprising:
an acoustic driver positioned to provide an acoustic signal to a user when the wearable audio device is worn and a drive signal is provided to the acoustic driver;
a system microphone outputting a system microphone signal, wherein the system microphone signal is representative of the acoustic signal; and
a control circuit, configured to:
generate an anti-noise signal based on a feedback signal wherein the feedback signal comprises the system microphone signal and an injected content signal;
generate an estimate of the feedback signal in an off-head state; and
determine a state of the wearable audio device by comparing the feedback signal to the estimate of the feedback signal, wherein the state of the wearable audio device represents whether the wearable audio device is on-head or off-head.

2. The wearable audio device of claim 1, wherein comparing the feedback signal to the estimate of the feedback signal comprises generating a metric of similarity between the feedback signal and estimate of the feedback signal and comparing the metric of similarity to a threshold.

3. The wearable audio device of claim 2, wherein the metric of similarity is generated with an adaptive filter.

4. The wearable audio device of claim 3, wherein the adaptive filter is a least means squared filter.

5. The wearable audio device of claim 2, wherein the feedback signal and the estimate of the feedback signal are each filtered before the feedback signal is compared to the estimate of the feedback signal.

6. The wearable audio device of claim 1, wherein the anti-noise signal is further based on an outer microphone signal, the outer microphone signal being output from an outer microphone and being representative of ambient noise.

7. The wearable audio device of claim 1, wherein the control circuit is further configured to perform at least one action upon determining that the state of the wearable audio device represents a state change.

8. The wearable audio device of claim 7, wherein the at least one action comprises pausing audio playback.

9. The wearable audio device of claim 7, wherein the at least one action comprises adjusting an aware mode.

10. The wearable audio device of claim 1, wherein the estimate of the feedback signal in the off-head state is based on inputting an outer microphone signal and the injected content signal to filters modeling transfer functions of the wearable audio device in an off-head state.

11. A wearable audio device with head state detection, comprising:
an acoustic driver positioned to provide an acoustic signal to a user when the wearable audio device is worn and a drive signal is provided to the acoustic driver;
a system microphone outputting a system microphone signal, wherein the system microphone signal is representative of the acoustic signal; and
a control circuit, configured to:
generate an anti-noise signal based on a feedback signal wherein the feedback signal comprises the system microphone signal and an injected content signal;
generate an estimate of the feedback signal in an on-head state; and
determine a state of the wearable audio device by comparing the feedback signal to the estimate of the feedback signal, wherein the state of the wearable audio device represents whether the wearable audio device is on-head or off-head.

12. The wearable audio device of claim 11, wherein comparing the feedback signal to the estimate of the feedback signal comprises generating a metric of similarity between the feedback signal and estimate of the feedback signal and comparing the metric of similarity to a threshold.

13. The wearable audio device of claim 12, wherein the metric of similarity is generated with an adaptive filter.

14. The wearable audio device of claim 13, wherein the adaptive filter is a least means squared filter.

15. The wearable audio device of claim 12, wherein the feedback signal and the estimate of the feedback signal are each filtered before the feedback signal is compared to the estimate of the feedback signal.

16. The wearable audio device of claim 11, wherein the anti-noise signal is further based on an outer microphone signal, the outer microphone signal being output from an outer microphone and being representative of ambient noise.

17. The wearable audio device of claim 11, wherein the control circuit is further configured to perform at least one action upon determining that the state of the wearable audio device represents a state change.

18. The wearable audio device of claim 17, wherein the at least one action comprises pausing audio playback.

19. The wearable audio device of claim 17, wherein the at least one action comprises adjusting an aware mode.

20. The wearable audio device of claim 11, wherein the estimate of the feedback signal in the on-head state is based on inputting an outer microphone signal and the injected content signal to filters modeling transfer function of the wearable audio device in an on-head state.
